(19) United States
(12) Patent Application Publication
(10) Pub. No.: US 2004/0015821 A1
(43) Pub. Date: Jan. 22, 2004

(54) System and method for interactive collaborative process management and project management

(75) Inventors: Peng Lu, Fremont, CA (US); Joseph Chiu, Fremont, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Tonbu, Inc.

(21) Appl. No.: 10/138,043

(22) Filed: May 1, 2002

Related U.S. Application Data
(60) Provisional application No. 60/287,919, filed on May 1, 2001.

(51) Int. Cl. G06F 9/44

(52) U.S. Cl. 717/103; 717/100

(57) ABSTRACT

A system and method for an interactive, collaborative process and project management computer system maps a process instance, operatively connected to a stand alone workflow tool, to a project instance and maps the project instance, operatively connected to a stand alone project management tool, to the process instance. These coordinated mappings are performed automatically, interchangeably, and synchronously in real time. The collaborative process and project management allows for event and condition driven interactions between a stand alone workflow tool and a stand alone project management tool without imposing a centralized integrated database upon these tools.

### RELATED APPLICATION

This application claims the benefit of U.S. Provisional Application No. 60/287,919, filed on May 1, 2001, which is hereby incorporated herein by reference.

### FIELD OF THE INVENTION

The present invention relates generally to the area of computer based process management systems and computer based project management systems. In particular, the present invention relates to a system and method for mapping a process model instance, operatively connected to a stand alone workflow tool, to a project model instance and for mapping the process instance, operatively connected to a stand alone workflow tool, to the project instance, which mappings are performed automatically, interchangeably, and synchronously.

### BACKGROUND OF THE INVENTION

In modem managerial practices, a multitude of work processes are usually necessary to accomplish a desired outcome, and these processes may vary from very simple processes to very complex processes. For example, in business, designing, developing, and/or manufacturing a new product or modifying an existing product present many challenges to product managers and engineers during their efforts to bring the product to market as efficiently as possible, within their marketing window of opportunity, while maintaining or even increasing product quality. Similar concerns are also present in areas such as the financial industries, education, legal and governmental services, and even private endeavors.

If a process is defined as an interrelated group or set of activities, perhaps represented as a network of activities on a directed graph whereby the sequencing of the activities is modeled by directed control connectors, control splits, and control joins, then a computerized process definition or model can be defined as a computerized representation of a process. A process instance then can be defined as a run time operational instantiation of a process based on a process definition and can include details of the process, such as roles and associated documents for every activity. A workflow then can be defined, according to The Workflow Reference Model of the Workflow Management Coalition, as a computerized facilitation or automation of a process in whole or in part. Workflow is concerned with the automation of procedures where documents, information, or tasks are passed between participants according to a defined set of rules to achieve, or contribute to, an overall goal. A workflow tool or workflow engine is software that defines, manages, and/or executes such workflows.

Similarly, the concept of a project is generally concerned with placing activities on a time line, often related to a calendar. Each project is given a period of time for completion through a specified step or task. A computerized project definition or model can be defined as a computerized representation of a project, and a project instance can be defined as a run time instantiation of a project. A project management tool is concerned with successfully describing how to manage a project having project constraints in areas such as scheduling, resource management, and cost control.

Most existing software programs have been developed to allow users to implement a process management or workflow tool, such as Tibco's Inconcert or Weblogic's Process Integrator, or a project management tool, such as Microsoft Project or Primvera, but not both. Existing stand alone programs are focused on either process management or project management.

In Leisten et al., U.S. Pat. No. 6,023,702, Method and Apparatus for a Process and Project Management Computer System, a method and apparatus for a process and project management computer system are described. Because process management and project management views are constructed according to project elements and process elements maintained in a common work object; the process management view and the project management view are not intended and cannot function as stand alone tools. The IBM Markflow program is an example of a software system that follows the paradigm disclosed by Leisten et al.

Although integrated process and project management systems have obvious benefits, many consumers already have made substantial investments in stand alone process management or project management systems. Consumers who already have an existing stand alone product for either process management or project management may elect to forego purchasing an integrated process and project management system that replicates what they already have or that requires relearning and transferring data to a new system. Consumers also may be discouraged from adding a stand alone process management or project management tool to compliment a product that they already own if the two programs will not function together conveniently. It therefore would be advantageous to have a system and method for mixing and matching stand alone workflow tools with stand alone project management tools, which system and method would be transparent to the user, convenient to use, and allow a user to choose which workflow tool and which project management tool to “plug into” the system. It also would be advantageous if this system could facilitate synchronous collaboration between a workflow tool and a project management tool that is selectively automatic. In this manner, any new or modified data or information in one tool can automatically and accurately be dispatched to the other tool so that both can appropriately process the data or information.

### SUMMARY OF THE INVENTION

A system and method for an interactive, collaborative process and project management computer system maps a process instance, operatively connected to a stand alone workflow tool, to a project instance and maps the project instance, operatively connected to a stand alone project management tool, to the process instance. These coordinated mappings are performed automatically, interchangeably, and synchronously in real time. The collaborative process and project management allows for event and condition driven interactions between a stand alone workflow tool and a stand alone project management tool without imposing a centralized integrated database upon these tools.

The present invention provides a collaborative process and project management computer system and method for interactive and collaborative process management and project management. Preferred embodiments of the present invention describe a real time, event or condition driven process and project management system for coordinating and facilitating dynamic or real time, synchronous collaboration between a stand alone workflow tool and a stand alone project management tool, which system is selectively automatic. Thus, under this process and project management system, each stand alone tool can appropriately process current data or information received by either tool in real time, to provide currently relevant and accurate information to a user. The process and project management system is transparent to a user and thus convenient to use, and allows a user to choose which workflow tool and which project management tool to “plug into” the process and project management system. The process and project management system is implemented using distinct process models and project models from which process model instances and project model instances are constructed. By mapping one kind of model instance to the other, a workflow tool or project management tool can be integrated into and interact in a collaborative manner with other process or project management tools in the system.

A process model and instance and a project model and instance are constructed to facilitate communications between a workflow tool and a project management tool. The models and instances are represented in a software language that is platform independent and can be used with Internet services and applications. Although the process and project management system is capable of being represented in other languages known to those skilled in the art, and may be more efficient in a newer language to be developed sometime in the future, currently XML (eXtensible Markup Language) is the preferred language to represent the models and other parts of the process and project management system in general. XML is a meta markup language, a language for creating a markup language, that allows programmers to create their own tags. XML is a markup language that can run on any platform, operating system, or environment and is designed to provide developers with a means to better describe their content. It has been developed to make exchanging data on the Internet easier and more efficient. XML is sufficiently robust and extensive that it can be used to describe not only content but also metadata, or information that describes other information, such as a catalogue does, and thereby make it easier to conduct efficient searches of Internet sites.

Preferred embodiments of the collaborative process and project management computer system comprise at least one process model instance constructed from a process model and at least one project model instance corresponding to the process model instance and constructed from a project model. The process model instance is in operative communication with a workflow tool and has a plurality of process model elements, and the project model instance is in operative communication with a project management tool and has a plurality of project model elements. Values derived from process data of the workflow tool are assigned to process model elements for communication to a project management tool, and values derived from project data of the project management tool are assigned to project model elements for communication to the workflow tool. The process and project management system further comprises a mapping system in operative communication with the process model instance and the project model instance, which is programmed to map a plurality of process model elements to a plurality of project model elements, map a plurality of project model elements to a plurality of process model elements, and implement a system manager to monitor for process and project conditions or events and control mappings between process model elements and project model elements.

More particularly, preferred embodiments comprise a mapping system or routine to create a new project model instance for and corresponding to each new process model instance and map modified process model elements to project model elements whenever a process model element is modified, or some other transition condition occurs such as a user command, time interval, or signal or message, and to create a new process model instance for and corresponding to each new project model instance and map modified project model elements to process model elements whenever a selected transition condition occurs. The mapping system also includes a system manager to monitor for process and project events and conditions, to manage identifiers of each process model instance and project model instance, and to control mappings between process model instances and corresponding project model instances.

Preferred embodiments are designed to be transparent with most commercially available workflow tools and project management tools. For each of many commercially available workflow and project management tools, an adapter makes the tool compatible with either a process or project model instance. Through these adapters, a workflow tool and project management tool can interoperate in conjunction with the interactive, collaborative system of the present invention. Once an interface or adapter operatively connects each kind of tool to the process and project management system and a process model instance and a project model instance are constructed, any event or condition from either tool can be dispatched to the other tool under the monitoring by and control of the system manager. Moreover, it is possible to configure the process and project management system for interactive, collaboration between three or more stand alone tools, such as two workflow tools and a project management tool or two project management tools and a workflow tool.

### BRIEF DESCRIPTION OF THE DRAWINGS

FIG. 1 is a diagram of a process and project management system operatively connected to a workflow tool and a project management tool.

FIG. 2 is an illustration of a process model instance including a process object and an activity object.

FIG. 3 is a flow diagram of a process model instance.

FIG. 4 is an illustration of a project model instance including a project object and a task object.

FIG. 5 is a flow diagram of a project model instance reflecting completion through an OR-split.

FIG. 6 is a flow diagram of mapping a process model instance to a project model instance in accordance with the preferred embodiment.

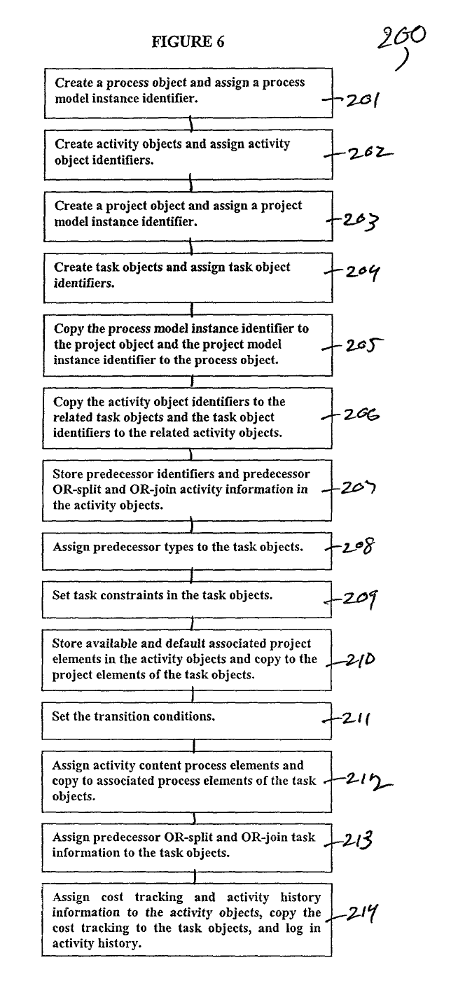

FIG. 7 is a flow diagram of mapping a project model instance to a process model instance in accordance with the preferred embodiment.

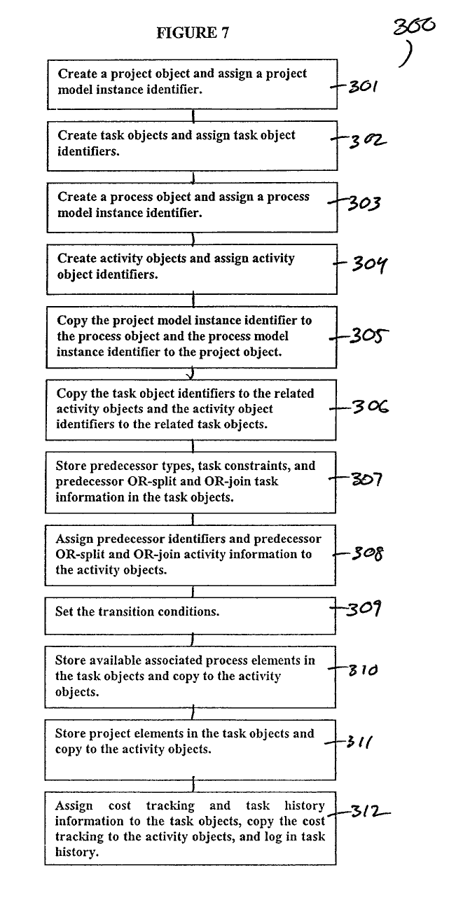

FIG. 8 is a segment for an activity object of a process model instance.

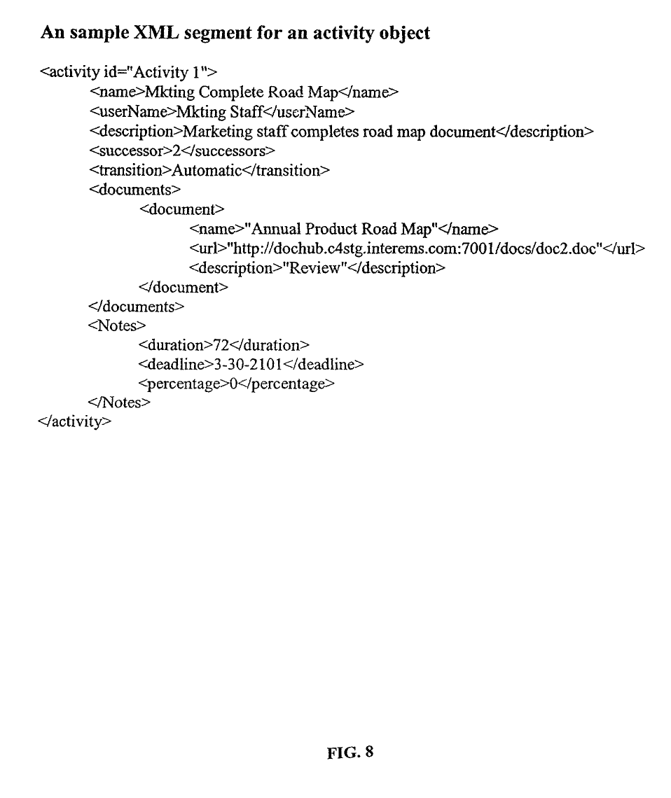

### DESCRIPTION OF THE PREFERRED EMBODIMENT

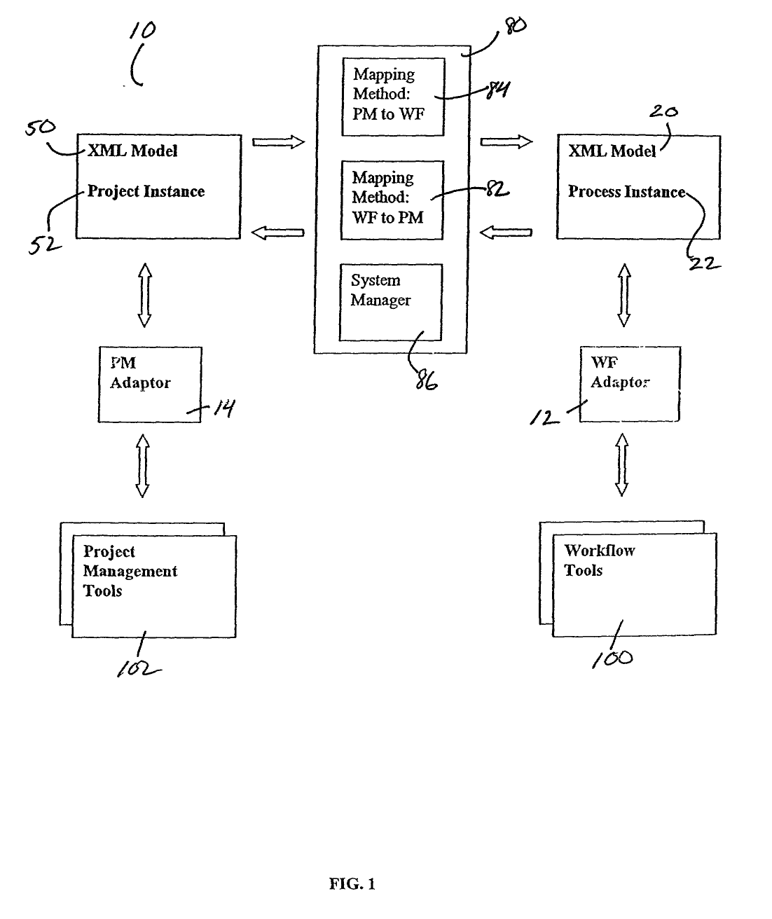

The preferred embodiment relates to an interactive and collaborative process and project management computer system in accordance with the present invention. As shown in FIG. 1, a workflow tool 100 and a project management tool 102 are selected for collaboration and operatively connected to the process and project management system 10. An adapter 12 for the workflow tool 100, and an adapter 14 for the project management tool 102 are constructed so that commercially available tools are compatible for operative communication with the process and project management system 10. Through these adaptors 12 and 14, the workflow tool 100 and project management tool 102 can collaborate through the process and project management system 10, so any event from either tool can be dispatched to the other tool.

The preferred embodiment of the collaborative process and project management computer system 10 comprises at least one process model instance 22 constructed from a process model 20 and at least one project model instance 52 corresponding to the process model instance 22 and constructed from a project model 50. The process model instance 22 is in operative communication with the workflow tool 100 and has a plurality of process model elements; the project model instance 52 is in operative communication with the project management tool 102 and has a plurality of project model elements. Values are derived from process data of the workflow tool 100 and assigned to process model elements for communication to the project management tool 102, and values are derived from project data of the project management tool 102 and assigned to project model elements for communication to the workflow tool 100. The process and project management system 10 further comprises a mapping system 80 in operative communication with the process model instance 22 and the project model instance 52, which is programmed to implement a mapping subroutine 82 to map a plurality of process model elements to a plurality of project model elements, to implement a mapping subroutine 84 to map a plurality of project model elements to a plurality of process model elements, and to implement a system manager 86 to monitor for process and project conditions and events and control mappings between process model elements and project model elements.

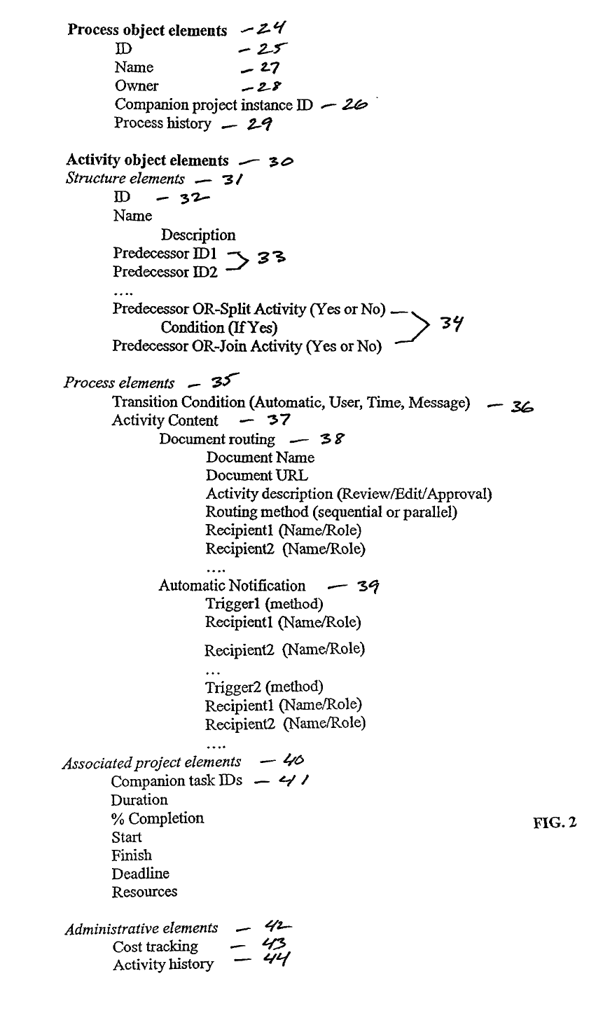

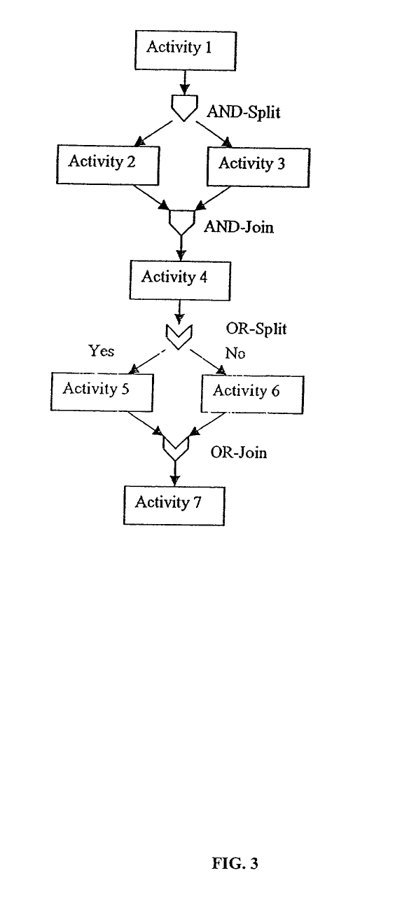

As shown in FIG. 2, the process model instance 22 is comprised of a process object 24 and as many activity objects 30 as there are activities in a process. The process object 24 may be comprised of several elements. These include a process model instance identifier 25 and companion or corresponding project model instance identifier 26, which are used to successfully dispatch data and information to a companion or corresponding process and project object. Also included are a name of the process and project 27, owner of the process and project 28, and memory for accumulating a process history 29. An activity object 30 is comprised of as many elements as are necessary to describe an activity. Preferably, there are four classes of elements: process structure elements 31, process elements 35, associated project elements 38, and process administrative elements 40. Process structure elements 31 are information about the related activity, including an activity object identifier 32, predecessor indentifiers 33, and predecessor OR-split activity and predecessor OR-join activity 34. Also included is the name of the activity. Process elements 35 include transition triggering events or conditions 36 and activity content 37 such as document routing information 38 and recipient notification information 39. Preferably, there are four kinds of transition conditions 36, which can be used in combination with each other. Transitions can be initiated automatically, whereby the system manager 86 continuously checks for an event or condition, initiated by a user command to the system manager, initiated upon a predetermined time interval, or initiated after a message or signal is received by the system manager. Notification of transitions is preferably automatic and an ordered list of recipients and their respective roles is provided for each notification method or event or condition triggering a transition. Associated project elements 40 include a companion or corresponding task identifier 41 and other information about an associated or companion or corresponding task object. Process administrative elements 42 are information about administrative matters related to the process and project, such as costs 43 and activity history 44. FIG. 3 is a flow diagram of an example process model instance. The boxes are activity objects and the chevrons are split and join routing control symbols.

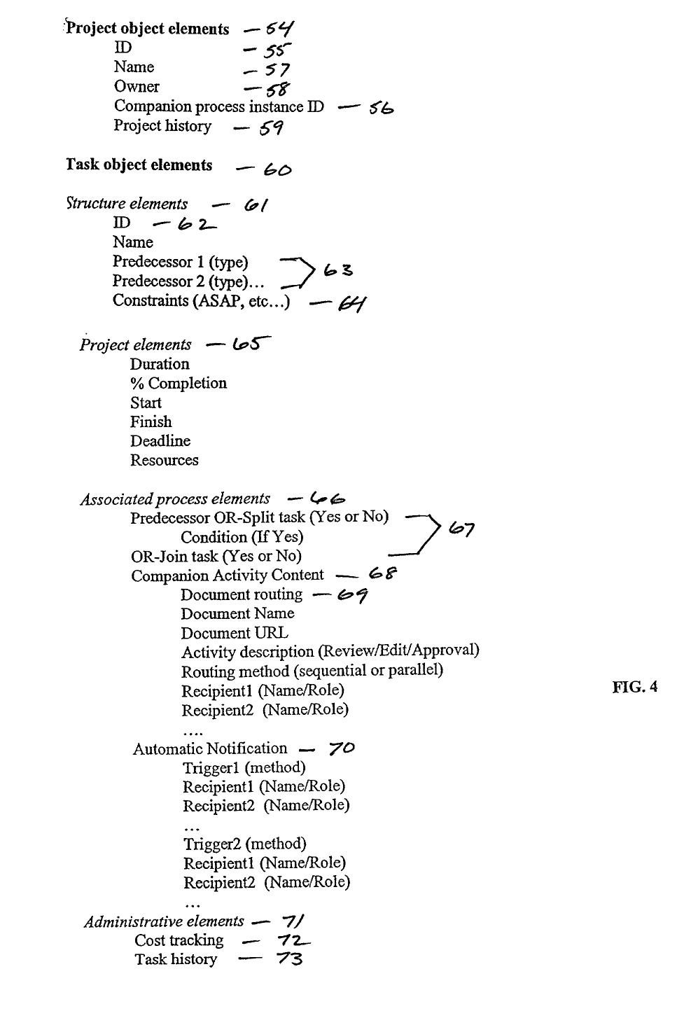

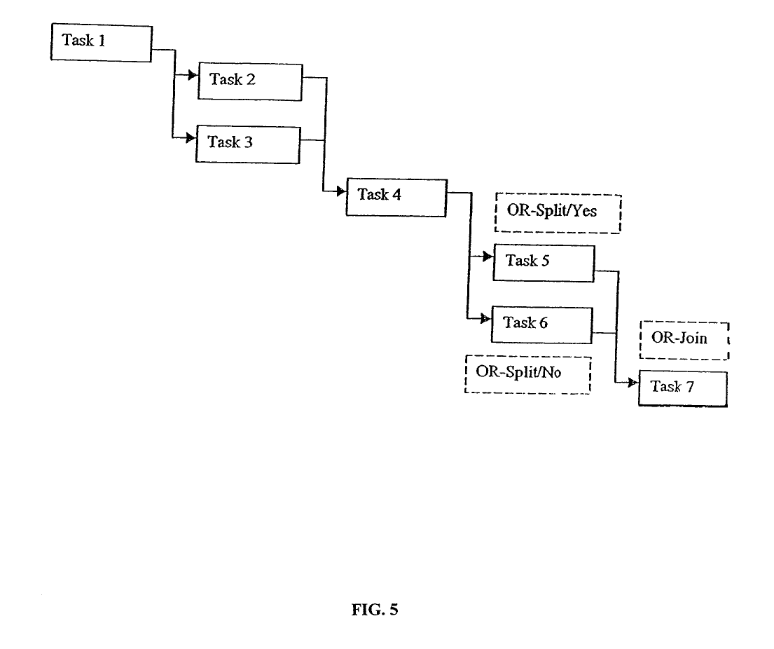

Similarly, as shown in FIG. 4, the project model instance 22 is comprised of a project object 24 and as many task objects 26 as there are tasks in a project. The project object 24 may be comprised of several elements. These include a project model instance identifier 55 and companion or corresponding process model instance identifier 56. Also included are a name of the process and project 57, owner of the process and project 58, and memory for accumulating a project history 59. A task object 60 may be comprised of as many elements as are necessary to describe a task. Preferably, there are four classes of elements: project structure elements 61, project elements 65, associated process elements 66, and project administrative elements 71. Project structure elements 61 are information about the task, including a task object identifier 62, predecessor types 63 (described below), and project task scheduling constraints 64 (also described below). Also included is the name of the task. Associated process elements 66 include predecessor OR-split and OR-join task information 67, and companion or corresponding activity content 68 such as document routing information 69 and recipient notification information 70. Notification of transitions is preferably automatic and an ordered list of recipients and their roles is provided for each notification method or event or condition triggering a transition. Project administrative elements 71 are information about administrative matters related to the process and project, such as costs 72 and task history 73. FIG. 5 is a flow diagram of an example project model instance. The boxes with solid outlines are task objects and the boxes with dashed outlines are split and join routing control symbols.

In operation, to map a process model instance to a project model instance for the first time, a process object is first created and assigned a process model instance identifier so that the system manager can monitor and control data flowing to and from the object. The system manager serves as an administrative and monitoring tool of the process and project management system. Although those skilled in the art are aware that the following steps may be arranged in other orders, then an activity object is created for each activity of a modeled process and each activity object is assigned an activity object identifier. Next, a project object is created and assigned a project model instance identifier and a task object is created for each task of a modeled project and each task object is assigned a task object identifier. Generally there is a project object corresponding to each process object and a task object corresponding to each activity object. The process model instance identifier is copied to the project object and the project model instance identifier is copied to the process object to create a correspondence. To create a similar correspondence, the activity object identifier of each activity object is copied to a companion activity identifier of the related task object, and the task object identifier of each task object is copied to a companion task identifier of the related activity object. Next, predecessor identifier and predecessor OR-split and OR-join activity information for each activity object are stored inside that activity object, and for each predecessor identifier in each activity object a predecessor type is assigned in the corresponding task object. Next, the task constraint in each task object is set. Next, in available associated project elements of the corresponding task object and default project schedule values otherwise are stored in each activity object, and the associated project elements are copied to project elements of the corresponding task object. Next, the transition condition for the activity object and task object is set. Next, activity content process elements are assigned to each activity object and copied to associated process elements of the corresponding task object. Next, to each predecessor OR-split activity and predecessor OR-join activity in each activity object, predecessor OR-split task or OR-join task information is assigned in the corresponding task object. Next, cost tracking and activity history for each activity object are stored in that activity object, the cost tracking element is copied to the corresponding task object, and the creation date of each activity object is logged in the activity history element of that activity object. Those skilled in the art are also aware that these above-described objects may be modified in various ways to meet the specific needs of a user. Finally, the appropriate above-described steps are repeated upon the occurrence of a transition event or condition for any modification to a process object or activity object originating from the workflow tool.

Also in operation, to map a project model instance to a process model instance for the first time, a project object is first created and assigned a project model instance identifier so that the system manager can monitor and control data flowing to and from the object. Although those skilled in the art are aware that the following steps may be arranged in other orders, then a task object is created for each task of a modeled project and each task object is assigned a task object identifier. Next, a process object is created and assigned a process model instance identifier and an activity object is created for each activity of a modeled project and each activity object is assigned an activity object identifier. Generally there is a process object corresponding to each project object and an activity object corresponding to each task object. The project model instance identifier is copied to the process object and the process model instance identifier is copied to the project object to create a correspondence. To create a similar correspondence, the task object identifier of each task object is copied to a companion task identifier of the related activity object, and the activity object identifier of each activity object is copied to a companion activity identifier of the related task object. Next predecessor types, a task constraint, and predecessor OR-split and OR-join task information are stored for each task object inside that task object. Next, to each predecessor type in each task object a predecessor identifier is assigned in the corresponding activity object, and for each predecessor OR-split task and predecessor OR-join task in each task object, predecessor OR-split or OR-join activity information is assigned in the corresponding activity object. Next, the transition condition for the activity object and task object is set. Next, in each activity object, available associated process elements of the corresponding activity object are stored and otherwise left blank. Next, the associated process elements are copied to a process element of the corresponding process object. Next, project elements are stored in the task object and copied to the corresponding activity object. Next, cost tracking and task history for each task object are stored in that task object, the cost tracking element is copied to the corresponding activity object, and the creation date of each task object is logged in the task history element of that task object. Those skilled in the art are also aware that these above-described objects may be modified in various ways to meet the specific needs of a user. Finally, the appropriate above-described steps are repeated upon the occurrence of a transition event or condition for any modification to a project object or task object originating from the project management tool.

Because split and join information is important to model synchronization, and because most project management tools do not handle splits or other branch tasks, special attention is given these routing control symbols. Referring to FIGS. 2 and 4, the example process instance with an OR-split activity in FIG. 2 is mapped to the example project instance in FIG. 4. Task 5 corresponding to Activity 5 is a “Yes” branch to Task 4. Task 6 corresponding to Activity 6 is a “No” branch to Task 4. Task 7 corresponding to Activity 7 is the OR-join to Tasks 5 and 6. When the project instance is being traversed and the “Yes” branch is selected, Task 5 is activated and Task 6 is no longer needed from a project management perspective. Consequently, Task 6 is automatically deemed completed so that the predecessor requirements of Task 7 are concerned only with Task 5. In actual operation, the project management tool may choose not to show Task 6 at all after the Task 5 branch is chosen. This is diagrammatically indicated by the thick, solid line across the entire bottom of Task 6 in FIG. 4. As those skilled in the art are aware, this paradigm can be expanded to include any number of alternative tasks.

In applying the process and project management system of the present invention to Microsoft Project, for example, there are four defined predecessor types,: finish-to-start (a task cannot start until another specified task has finished), start-to-start (a task cannot start until another specified task has started), finish-to-finish (a task cannot finish until another specified task has finished), and start-to-finish (a task cannot finish until another specified task has started). The start-to-finish dependency type can be used for just-in-time scheduling up to a milestone or the project finish date to minimize the risk of a task finishing late if its dependent tasks slip. If a related task needs to finish before the milestone or project finish date, but it does not matter exactly when and a late finish affecting the just-in-time task is undesirable, this kind of dependency can be created between the task to be scheduled just in time (the predecessor) and its related task (the successor). When progress on the successor task is updated, it will not affect the scheduled dates of the predecessor task. These predecessor types are important information used by the present invention to construct structure elements of the activity object. Another element that affects structure elements of the activity object is the task constraint. Referring again to the use of Microsoft Project as the project management stand alone system, Microsoft Project provides for a project task constraint which is a restriction or limitation that a user or project management tool sets on the start or finish date of a task. For example, a user can specify that a task must start on a particular date or finish no later than a particular date. Then, for example, when using the Microsoft Project project management tool, if the user adds a new task to a project that is scheduled from the start date, Microsoft Project automatically assigns the As Soon As Possible constraint. Conversely, if the user adds a new task to a project that is scheduled from the finish date, Microsoft Project automatically assigns the As Late As Possible constraint. The preferred embodiment has eight designated constraint types for Microsoft Project: As Soon As Possible (flexible scheduling impact; with this constraint, a task is scheduled as early as it can be scheduled, given other scheduling parameters; no additional date restrictions are put on the task; this is the default constraint for projects scheduled from the start date), As Late As Possible (flexible scheduling impact; with this constraint, a task is scheduled as late as it can be scheduled, given other scheduling parameters; no additional date restrictions are put on the task; this is the default constraint for projects scheduled from the finish date), Finish No Later Than (moderate scheduling impact; this constraint indicates the latest possible date that a task can be completed; it can be finished on or before the specified date; for projects scheduled from the finish date, this constraint is applied when a finish date is selected for a task), Start No Later Than (moderate scheduling impact; this constraint indicates the latest possible date that a task can begin; it can start on or before the specified date; for projects scheduled from the finish date, this constraint is applied when a start date is selected for a task), Finish No Earlier Than (moderate scheduling impact; this constraint indicates the earliest possible date that a task can be completed; it cannot finish any time before the specified date; for projects scheduled from the start date, this constraint is applied when a finish date is selected for a task), Start No Earlier Than (moderate scheduling impact; this constraint indicates the earliest possible date that a task can begin; it cannot start any time before the specified date; for projects scheduled from the start date, this constraint is applied when a start date is selected for a task), Must Start On (inflexible scheduling impact; this constraint indicates the exact date on which a task must begin; other scheduling parameters such as task dependencies, lead or lag time, resource leveling, and delay become secondary to this requirement), and Must Finish On (inflexible scheduling impact; this constraint indicates the exact date on which a task must be completed; other scheduling parameters such as task dependencies, lead or lag time, resource leveling, and delay become secondary to this requirement). Information about these eight designated constraint types is considered as part of the model synchronization.

An interactive collaborative process and project management system in accordance with the present invention comprises a process model instance, a project model instance, a mapping of the process instance to the project instance, and a mapping of the project instance to the process instance. Alternatively, an interactive collaborative process and project management system in accordance with the present invention comprises a process model instance operatively coupled to a workflow tool, a project model instance operatively coupled to a project management tool, a mapping of the process instance to the project instance; and a mapping of the project instance to the process instance.

Although the preferred embodiment has been described here, numerous changes and variations can be made and the scope of the present invention is intended to be defined by the claims herein.

That which is claimed

1. A collaborative process and project management computer system for synchronous, event and condition driven collaboration between a stand alone workflow tool having process data and a corresponding stand alone project management tool having project data, comprising:
a process model instance, in operative communication with the workflow tool and having a plurality of process model elements;
a project model instance corresponding to the process model instance, in operative communication with the project management tool and having a plurality of project model elements;
a mapping system in operative communication with the process model instance and the project model instance and programmed to map a plurality of process model elements to a plurality of corresponding project model elements, to map a plurality of project model elements to a plurality of corresponding process model elements, and to implement a system manager to monitor for process and project events and conditions and control a mapping between the process model elements and the project model elements, so that values derived from process data are assigned to process model elements for communication to the project management tool, and values derived from project data are assigned to project model elements for communication to the workflow tool.

2. The process and project management system of claim 1, wherein the system manager monitors for an event or condition upon the occurrence of a transition condition selected from the group of transition conditions consisting of continuous monitoring, user initiated monitoring, time interval monitoring, message initiated monitoring, and any combination of the previously described transition conditions.

3. The process and project management system of claim 1, wherein the process model instance has a process object including a process model instance identifier, a name, owner identification, corresponding project model instance identifier, and process history.

4. The process and project management system of claim 3, wherein the process model instance has at least one activity object associated with the project object and each activity object includes process structure element data, process element data, associated project elements data, and process administrative element data.

5. The process and project management system of claim 1, wherein the project model instance has a project object including a project model instance identifier, a name, owner identification, corresponding process model instance identifier, and project history.

6. The process and project management system of claim 5, wherein the project model instance has at least one task object associated with the project object and each task object includes project structure element data, project element data, associated process element data, and project administrative element data.

7. The process and project management system of claim 6, wherein the project structure elements of a task object include predecessor types selected from the group of predecessor types consisting of finish-to-start, start-to-start, finish-to-finish, and start-to-finish.

8. The process and project management system of claim 1, wherein the project structure elements of a task object include scheduling constraints selected from the group of scheduling constraints consisting of as soon as possible, as late as possible, finish no later than, start no later than, finish no earlier than, start no earlier than, must start on, and must finish on.

9. The process and project management system of claim 1, wherein an extensible markup language process model is used to implement the process model instance and an extensible markup language project model is used to implement the project model instance.

10. The process and project management system of claim 1, wherein an OR-split having at least two branches is processed by activating the selected branch and automatically designating the other branches as completed.

11. The process and project management system of claim 1, further comprising a workflow tool adapter to operatively connect a commercially available workflow tool to the collaborative system.

12. The process and project management system of claim 1, further comprising a project tool adapter to operatively connect a commercially available project management tool to the collaborative system.

13. A collaborative process and project management computer system for synchronous, event and condition driven collaboration between a stand alone workflow tool having process data and a corresponding stand alone project management tool having project data, comprising:
a process model instance means in operative communication with the workflow tool;
a project model instance means in operative communication with the project management tool;
a mapping means in operative communication with the process model instance means and the project model instance means for mapping process data from the process model instance means to the project model instance means and project data from the project model instance means to the process model instance means, and for implementing a system manager to monitor for process and project events and conditions and control a mapping between the process model instance means and the project model instance means, so that values derived from process data are assigned to the process model instance means for communication to the project management tool, and values derived from project data are assigned to the project model instance means for communication to the workflow tool.

14. A mapping routine used in a collaborative process and project management computer system for synchronous, event and condition driven collaboration between a process model instance of a stand alone workflow tool, wherein the process model instance includes a plurality of process model elements, and a corresponding project model instance of a stand alone project management tool, wherein the project model instance includes a plurality of project model elements, comprising:
a mapping subroutine to create a new project model instance corresponding to a new process model instance and to map modified process model elements to project model elements;
a mapping subroutine to create a new process model instance corresponding to a new project model instance and to map modified project model elements to process model elements;
a system manager to monitor for process and project events and conditions, to manage at least one identification of each process model instance and project model instance, and to control a mapping between a process model instance and a corresponding project model instance.

15. A method for mapping a process model instance of a stand alone workflow tool, wherein the process model instance includes a process object and at least one activity object, to a corresponding project model instance of a stand alone project management tool, wherein the project model instance includes a project object and at least one task object, comprising:
(a) creating a process object;
(b) assigning a process model instance identifier to the process object;
(c) creating at least one activity object;
(d) assigning an activity object identifier to each activity object;
(e) creating a project object corresponding to the process object;
(f) assigning a project model instance identifier to the project object;
(g) copying the process model instance identifier to the project object;
(h) copying the project model instance identifier to the process object;
(i) creating a corresponding task object for each activity object;
(j) assigning a task object identifier to each task object;
(k) storing predecessor identifier and predecessor OR-split and OR-join activity information for each activity object inside that activity object;
(l) copying the activity object identifier of each activity object to a companion activity identifier of the corresponding task object and the task object identifier of each task object to a companion task identifier of the corresponding activity object;
(m) assigning to each predecessor identifier in each activity object a predecessor type in the corresponding task object;
(n) setting the task constraint in each task object;
(o) storing in each activity object available associated project elements of the corresponding task object t and default project schedule values otherwise;
(p) copying the associated project elements to project elements of the corresponding task object;
(q) setting a transition condition for the activity object and task object;
(r) assigning activity content process elements to each activity object;
(s) copying the activity content process elements to associated process elements of the corresponding task object;
(t) assigning to each predecessor OR-split activity and predecessor OR-join activity in each activity object predecessor OR-split task and OR-join task information in the corresponding task object;
(u) providing cost tracking and activity history for each activity object;
(v) copying the cost tracking element to the corresponding task object;
(w) logging the creation date of the activity element; and
(x) repeating the appropriate above-described steps for any modification to a process object or activity object originating from the workflow tool.

16. A method for mapping a project model instance of a stand alone project management tool, wherein the project model instance includes a project object and at least one task object, to a corresponding process model instance of a stand alone workflow tool, wherein the process model instance includes a process object and at least one activity object, comprising:
(a) creating a project object;
(b) assigning a project model instance identifier to the project object;
(c) creating at least one task object;
(d) assigning a task object identifier to each task activity;
(e) creating a process object corresponding to the project object;
(f) assigning a process model instance identifier to the process object;
(g) copying the project model instance identifier to the process object;
(h) copying the process model instance identifier to the project object;
(i) creating a corresponding activity object for each task object;
(j) assigning a task object identifier to each task object;
(k) storing predecessor type, a task constraint, and predecessor OR-split and OR-join task information for each task object inside that task object;
(l) copying the task object identifier of each task object to a companion task identifier of the corresponding activity object and the activity object identifier of each activity to a companion activity identifier of the corresponding task object.
(m) assigning to each predecessor type in each task object a predecessor identifier in the corresponding activity object;
(n) assigning to each predecessor OR-split task and predecessor OR-join task in each task object predecessor OR-split and OR-join activity information in the corresponding activity object;
(o) setting a transition condition for the activity object and task object;
(p) storing in each activity object available associated process elements of the corresponding activity object and leaving them blank otherwise;
(q) copying the associated process elements to the process element of the corresponding process object;
(r) storing project elements in the task object;
(s) copying the project elements to the corresponding activity object;
(t) providing cost tracking and task history for each task object;
(u) copying the cost tracking element to the corresponding activity object;
(v) logging the creation date of each task object; and
(w) repeating the appropriate above-described steps for any modification to a project object or activity object originating from the project management tool.
